(19) United States
(12) Patent Application Publication
(10) Pub. No.: US 2019/0188145 A1
(43) Pub. Date: Jun. 20, 2019

(54) CACHE MEMORY DEVICE AND FPGA INCLUDING THE SAME

(71) Applicants: SK hynix Inc., Icheon (KR); Sogang University Industry-University Cooperation Foundation, Seoul (KR)

(72) Inventors: Hyun SO, Seoul (KR); Hyunwoo PARK, Yongin (KR); Hyukjun LEE, Seoul (KR)

(21) Appl. No.: 16/109,293

(22) Filed: Aug. 22, 2018

(30) Foreign Application Priority Data
Dec. 19, 2017 (KR) 10-2017-0174713

(51) Int. Cl. G06F 12/0895

(52) U.S. Cl. CPC G06F 12/0895; G06F 2212/1024

(57) ABSTRACT

A cache memory device includes a tag memory configured to store tag data for a plurality of ways corresponding to a set address; and a plurality of data memories each configured to store data corresponding to the plurality of ways that correspond to the set address, wherein each of the plurality of data memories is configured to store a corresponding one of a plurality of divisions of a plurality of word data, the plurality of word data corresponding to a same set address and a same way address, the plurality of word data being divided into the plurality of divisions.

### CROSS-REFERENCE TO RELATED APPLICATIONS

The present application claims priority under 35 U.S.C. § 119(a) to Korean Patent Application No. 10-2017-0174713, filed on Dec. 19, 2017, which is incorporated herein by reference in its entirety.

### BACKGROUND

### 1. Technical Field

Various embodiments of the present disclosure relate to a cache memory device and a Field Programmable Gate Array (FPGA) including the cache memory device.

### 2. Related Art

FIG. 1 is a block diagram illustrating a conventional FPGA.

An FPGA is a type of Programmable Logic Device (PLD) that is widely used to design digital circuits that perform specific operations through programs.

The FPGA of FIG. 1 includes configurable logic blocks (CLBs) 1, input/output blocks (IOBs) 4, Block Random Access Memories (BRAMs) 3, Delay Locked Loops (DLLs) 2, and configurable connection circuits that connect the CLBs, the IOBs, the BRAMs, and the DLLs.

A processor can be implemented using the FPGA, and the processor is referred to as a soft processor.

At this time, the FPGA can implement a cache memory using the internal BRAM 3.

The FPGA includes an SRAM-based BRAM 3, which consumes at least twice as much power as any of other devices in the FPGA consumes.

Accordingly, a technique has been proposed for reducing power consumption of the FPGA by using a memory, such as a spin-transfer torque magnetic random access memory (STT-MRAM), which has a larger storage capacity per unit area than an SRAM and is nonvolatile.

However, a nonvolatile memory such as an STT-MRAM has a longer read/write latency than an SRAM. Therefore, performance degradation due to the longer read/write latency should be improved when a soft processor is implemented using an FPGA in which the STT-MRAM is included.

Especially, a cache memory included in the soft processor may further degrade performance of the soft processor when there are cache misses. Therefore, when the cache memory is implemented using the BRAM 3 having a long latency, the performance degradation of the soft processor may be more significant.

### SUMMARY

In accordance with the present teachings, a cache memory device may include a tag memory configured to store tag data for a plurality of ways corresponding to a set address; and a plurality of data memories each configured to store data corresponding to the plurality of ways that correspond to the set address, wherein each of the plurality of data memories is configured to store a corresponding one of a plurality of divisions of a plurality of word data, the plurality of word data corresponding to a same set address and a same way address, the plurality of word data being divided into the plurality of divisions.

In accordance with the present teachings, an FPGA may comprise a cache memory device implemented with a plurality of Block Random Access Memories (BRAMs); and a processor core configured to control the cache memory device, wherein the cache memory device comprises: a tag memory configured to store tag data for a plurality of ways corresponding to a set address; and a plurality of data memories configured to store data corresponding to the plurality of ways corresponding to the set address, wherein each of the plurality of data memories is configured to store a corresponding one of a plurality of divisions of a plurality of word data, the plurality of word data corresponding to a same set address and a same way address, the plurality of word data being divided into the plurality of divisions.

In accordance with the present teachings, a method of controlling a cache memory device comprising a tag memory and a plurality of data memories, the method comprising: receiving a request and a requested address; extracting a tag address and a set address from the requested address; reading tag data and word data from the tag memory and the plurality of data memories, respectively, the tag data and the word data being read from a plurality of ways of a set corresponding to the set address; comparing the tag data with the tag address to determine whether there is a cache hit or a cache miss; when there is the cache hit, determining whether the request is a write request or a read request; when the request is the write request, writing write data in a corresponding data memory; and when the request is the read request, outputting the word data read from the plurality of data memories.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed novelty, and explain various principles and advantages of those embodiments.

FIG. 1 shows a block diagram illustrating a conventional FPGA.

FIG. 2 shows a block diagram illustrating an FPGA including a cache memory device according to an embodiment of the present disclosure.

FIG. 3 shows a flow chart illustrating a method for controlling a cache memory device according to an embodiment of the present disclosure.

### DETAILED DESCRIPTION

The following detailed description references the accompanying figures in describing exemplary embodiments consistent with this disclosure. The exemplary embodiments are provided for illustrative purposes and are not exhaustive. Additional embodiments not explicitly illustrated or described are possible. Further, modifications can be made to presented embodiments within the scope of the present teachings. The detailed description is not meant to limit this disclosure. Rather, the scope of the present disclosure is defined only in accordance with the presented claims and equivalents thereof.

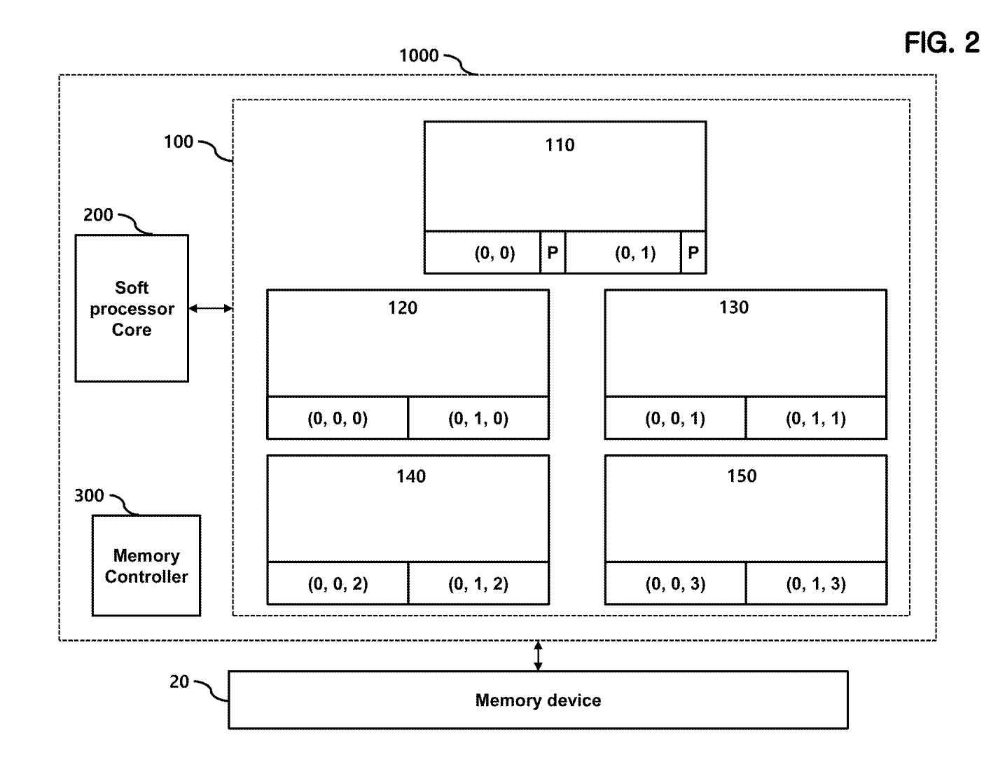

FIG. 2 shows a block diagram illustrating an FPGA 1000 including a cache memory device 100 according to an embodiment of the present disclosure.

The FPGA 1000 according to an embodiment of the present disclosure implements a soft processor.

The term “soft processor” can be also used to describe the FPGA 1000 in the following description.

The FPGA 1000 includes a soft processor core 200 and the cache memory device 100.

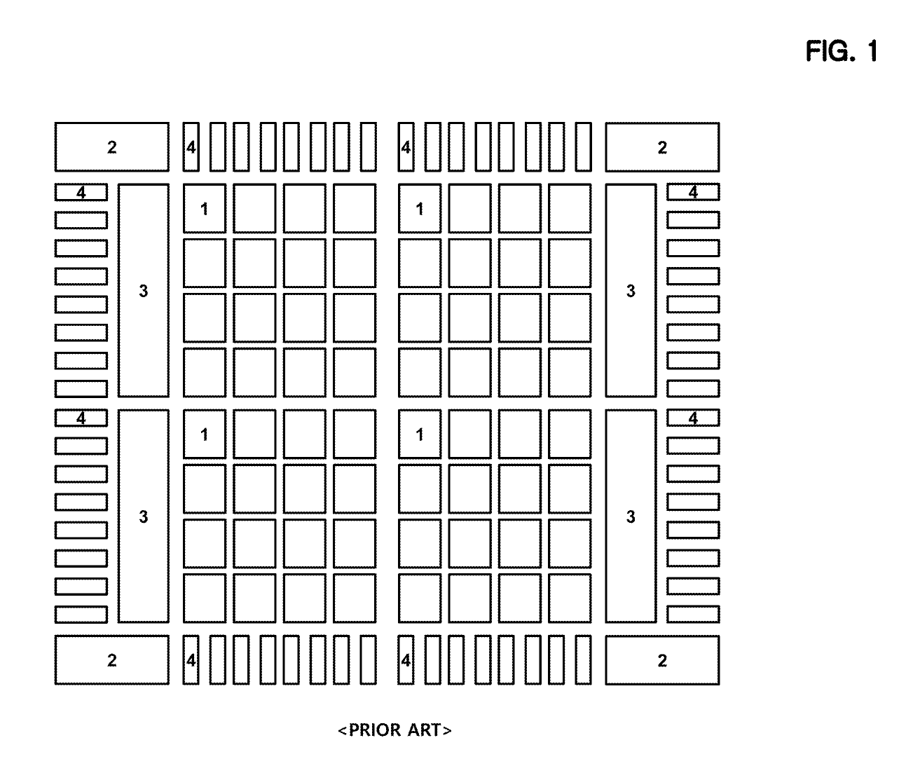

The soft processor core 200 may be implemented using components included in an FPGA, such as a plurality of CLBs, which may correspond to the CLBs 1 shown in FIG. 1.

The soft processor core 200 controls the cache memory device 100.

The FPGA 1000 further includes a memory controller 300 that controls read/write operations of an external memory device 20.

In the embodiment shown in FIG. 2, the memory controller 300 is implemented separately from the soft processor core 200. However, in another embodiment, the memory controller 300 may be implemented as part of the soft processor core 200.

The soft processor core 200 or the memory controller 300 can be implemented using conventional arts. Therefore, descriptions thereof are not provided in detail herein.

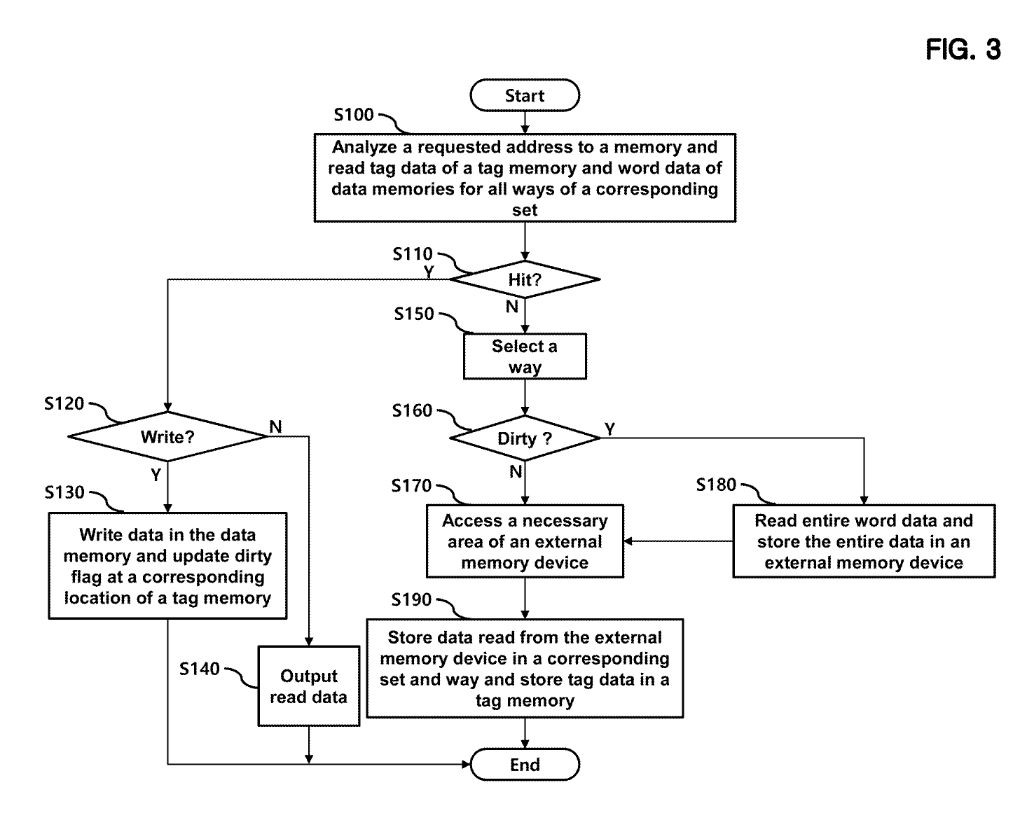

A specific method for controlling the cache memory device 100 will be described in detail with reference to FIG. 3.

In an embodiment, the cache memory device 100 uses a set-associative mapping technique.

A set number, a tag number, and a word number are derived from a read or write address for the external memory device 20.

The set number, the tag number, and the word number may be also referred to as a set address, a tag address, and a word address, respectively.

The cache memory device 100 includes a tag memory 110 and a plurality of data memories 120 to 150.

In this embodiment shown in FIG. 2, each of the tag memory 110 and the plurality of data memories 120 to 150 may be implemented using a component included in an FPGA, such as a BRAM that may correspond to the BRAM 3 shown in FIG. 1.

The tag memory 110 stores a plurality of tag data corresponding to a set address and a plurality of way addresses.

The plurality of data memories 120 to 150 store a plurality of word data corresponding to a same set address and a same way address.

FIG. 2 illustrates a case where one set includes two ways allocated thereto and one way includes four words. However, embodiments are not limited thereto.

The number of ways to be allocated to one set and the number of word data to be included in one way may vary according to embodiments.

In this embodiment shown in FIG. 2, a word corresponds to a data processing unit of the FPGA 1000.

In FIG. 2, (x, y) in the tag memory 110 represents a y-th way of an x-th set, and (i, j, k) in the data memory 120 represents a k-th word of a j-th way of an i-th set. In an embodiment in which one set includes two ways and one way includes four words, x and i are 0 or positive integers, y and j are 0 or 1, and k is 0, 1, 2, or 3.

First, operations of the soft processor core 200 and the cache memory device 100 will be described by taking operations for handling a read request as an example.

When the soft processor core 200 provides a read command (or a read request) and a read address to the cache memory device 100, a set address and a tag address are automatically extracted from the read address.

Tag data and word data corresponding to the set address are output from the tag memory 110 and the data memories 120 to 150, respectively.

The tag address can be compared with the tag data output from the tag memory 110 to determine whether there is a cache hit or a cache miss. In an embodiment, the soft processor core 200 compares the tag address with the tag data output from the tag memory 100.

The tag data output from the tag memory 110 may include a dirty flag indicating a dirty state, and a valid flag indicating validity.

In the tag memory 110 of FIG. 2, P represents a padding area for filling the remaining space that is not occupied by the tag data.

In this embodiment, it is assumed that the cache memory device 100 uses two ways.

A case where there is a read request for a 0th set and a 0th word in the cache memory device 100 will be described.

When the read request is provided from the soft processor core 200 to the cache memory device 100, tag data of a 0th way and tag data of a 1st way, which correspond to the 0th set, are output from the tag memory 110.

A 0th word of the 0th way of the 0th set and a 0th word of the 1st way of the 0th set are outputted from the data memory 120.

A tag address is extracted from a requested read address, and is compared with the tag data of the 0th way and the tag data of the 1st way, respectively, to judge whether there is a way in which a cache hit occurs.

The 0th word data of the way in which the cache hit has occurred can be provided in response to the read request.

It is preferable to store as many word data as possible that share a same set number and a same word number, in order to increase a cache hit rate, provided that the capacities of the plurality of data memories 120 to 150 are allowed.

In an embodiment, when a cache memory device uses a plurality of ways, a plurality of word data may be divided into a plurality of data divisions and each data division may be distributed in at least two data memories.

More specifically, in an embodiment of the present disclosure, one or more word data sharing a same set number and a same word number may be allocated to one data memory.

In the embodiment of FIG. 2, a plurality of ways sharing a same set number and a same word number are allocated in a data memory. For example, in FIG. 2, a 0th way and a 1st way, which share the 0th set and the 0th word, are allocated in the data memory 120; a 0th way and a 1st way, which share the 0th set and a 1st word, are allocated in the data memory 130; a 0th way and a 1st way, which share the 0th set and a 2nd word, are allocated in the data memory 140; and a 0th way and a 1st way, which share the 0th set and a 3rd word, are allocated in the data memory 150. That is, the 0th word of the 0th or 1st way is allocated to the data memory 120, the 1st word is allocated to the data memory 130, the 2nd word is allocated to the data memory 140, and the 3rd word is allocated to the data memory 150.

In an embodiment, one word corresponding to the same set and the same way may be assigned to one data memory, but in some other embodiments more than one word may be assigned to one data memory. Accordingly, when a read request for some words is provided, data may be read by activating only a data memory including the words to be read, instead of reading data from all the data memories.

That is, in the aforementioned embodiment, when the read request for reading data corresponding to the 0th set, the 0th way, and the 0th word is provided, only the data memory 120 can be activated to access the 0th word of the 0th way of the 0th set.

Next, the operation of the soft processor core 200 and the cache memory device 100 will be described by taking operations for handling a write request as an example.

When the soft processor core 200 provides a write command (or a write request) and a write address to the cache memory device 100, a set address is automatically extracted from the write address.

Thereafter, tag data for a plurality of ways corresponding to the set address is outputted from the tag memory 110.

A tag address is also automatically extracted from the write address provided from the soft processor core 200. The tag address is compared with the tag data output from the tag memory 110, in order to determine whether there is a cache hit or a cache miss.

When the cache hit has occurred in any one of the plurality of ways, a word to be written is stored in a corresponding way of a corresponding data memory.

At this time, if a dirty flag of the tag data is not in a dirty state, a write operation to the tag memory 110 may be performed by the soft processor core 200 so as to update the dirty flag as a dirty state.

It is necessary to store data of the external memory device 20 in an empty way of the cache memory device 100 when a cache miss has occurred in the cache memory device 100 at a time of processing a read or write request.

If a cache miss has occurred but there is no empty way corresponding to the set address, a victim way may be selected among the plurality of ways and may be evicted by referring to a dirty flag. After that, new data may be written in the victim way or may be overwritten on the evicted victim way.

In this embodiment, the tag address or number is stored in an empty way of the tag memory 110, and the data read from the external memory device 20 is divided into a plurality of word data, and the plurality of word data are distributed and stored in the plurality of data memories 120 to 150.

When the plurality of word data are written, a plurality of words sharing a same set number and a same way number are stored in a plurality of data memories in a distributed manner, so that write operations for the plurality of word data may be performed in parallel.

Thus, even when a BRAM is implemented with a memory device having a long write latency, such as an STT-MRAM, the write performance of an FPGA associated with the BRAM may not be degraded.

FIG. 3 shows a flow chart illustrating a method for controlling a cache memory device according to an embodiment of the present disclosure.

At step S100, a requested address to the cache memory device is analyzed, and tag data is read from a tag memory and word data is read from data memories. The tag data and the word data are read from all ways of a set corresponding to the requested address.

Thereafter, the tag data is compared with a tag address extracted from the requested address to determine whether there is a cache hit or a cache miss.

If there is a cache hit, it is determined whether a request is a write request at step S120.

If the request is the write request, write data is written to a data memory, and a dirty flag at a corresponding location of the tag memory is updated at step S130.

If it is determined at step S120 that the request is not the write request, for example, the request is a read request, read data is output to a soft processor core at step S140 and the process is terminated.

If there is no cache hit, for example, there is a cache miss, a way is selected at step S150.

In this case, the selected way is an empty way or a victim way selected from non-empty ways.

Thereafter, a dirty flag in the tag data is checked, in order to determine whether the dirty flag is in a dirty state or not at step S160.

If the dirty flag is not in the dirty state, an external memory device is accessed at step S170. Data read from the external memory device is stored in the corresponding set and way of the data memory and corresponding tag data is stored in the tag memory at step S190.

If it is determined that the dirty flag is in the dirty state at step S160, the entire word data corresponding to the corresponding set and way are read from the data memory and stored in the external memory device at step S180.

Thereafter, the process goes to step S170.

In an embodiment of the present disclosure, a BRAM is implemented with a nonvolatile memory device such as an STT-MRAM.

When a cache memory device uses a BRAM implemented with a nonvolatile memory device, the cache memory device advantageously has a greater degree of integration compared to a conventional device that uses an SRAM. Accordingly, the capacity of the cache memory device may be increased.

The performance of the cache memory device can be improved because a cache hit rate is increased when the capacity of the cache memory device is increased.

In addition, when the BRAM is implemented with the nonvolatile memory device, the power consumption of the BRAM can be reduced by reducing the static current consumption, as compared with the device using the SRAM.

In embodiments of the present disclosure, a plurality of word data corresponding to the same set and the same way are distributed and stored in a plurality of data memories, and thus it is possible to perform read or write operations in parallel.

As a result, a read/write speed of a cache memory device is improved compared to other devices, so that the performance degradation can be reduced even when used in conjunction with a memory device having a poor write latency, such as an STT-MRAM.

Although various embodiments have been described for illustrative purposes, it will be apparent to those skilled in the art that various changes and modifications may be made to the described embodiments without departing from the spirit and scope of the disclosure as defined by the following claims.

What is claimed is:

1. A cache memory device, comprising:
a tag memory configured to store tag data for a plurality of ways corresponding to a set address; and
a plurality of data memories each configured to store data corresponding to the plurality of ways that correspond to the set address,
wherein each of the plurality of data memories is configured to store a corresponding one of a plurality of divisions of a plurality of word data, the plurality of word data corresponding to a same set address and a same way address, the plurality of word data being divided into the plurality of divisions.

2. The cache memory device of claim 1, wherein each of the plurality of data memories stores one or more word data among the plurality of word data corresponding to the same set address and the same way address.

3. The cache memory device of claim 2, wherein each of the plurality of data memories stores one word data among the plurality of word data corresponding to the same set address and the same way address.

4. The cache memory device of claim 1, wherein each of the plurality of data memories stores a plurality of data corresponding to a same set address, a same word, and different ways.

5. The cache memory device of claim 1, wherein tag data includes a dirty flag indicating a dirty state of a corresponding way.

6. The cache memory device of claim 1, wherein the tag memory and the plurality of data memories are nonvolatile.

7. A Field Programmable Gate Array (FPGA), comprising:
a cache memory device implemented with a plurality of Block Random Access Memories (BRAMs); and
a processor core configured to control the cache memory device,
wherein the cache memory device comprises:
a tag memory configured to store tag data for a plurality of ways corresponding to a set address; and
a plurality of data memories configured to store data corresponding to the plurality of ways corresponding to the set address,
wherein each of the plurality of data memories is configured to store a corresponding one of a plurality of divisions of a plurality of word data, the plurality of word data corresponding to a same set address and a same way address, the plurality of word data being divided into the plurality of divisions.

8. The FPGA of claim 7, wherein each of the tag memory and a plurality of data memories is implemented with a BRAM among the plurality of BRAMs.

9. The FPGA of claim 7, wherein each of the plurality of data memories stores one or more word data among the plurality of word data corresponding to the same set address and the same way address.

10. The FPGA of claim 9, wherein each of the plurality of data memories stores one word data among the plurality of word data corresponding to the same set address and the same way address.

11. The FPGA of claim 7, wherein each of the plurality of data memories stores a plurality of data corresponding to a same set address, a same word, and different ways.

12. The FPGA of claim 7, wherein tag data includes a dirty flag indicating a dirty state of a corresponding way.

13. The FPGA of claim 12, wherein when the processor core provides a memory address of an external memory device to the cache memory device, the cache memory device outputs a plurality of tag data for a plurality of ways output from the tag memory according to a set address extracted from the memory address, and the processor core compares a tag address extracted from the memory address and the plurality of tag data to determine a cache hit or a cache miss.

14. The FPGA of claim 13, wherein the processor core provides a read request to a data memory among the plurality of data memories, the data memory including data corresponding to a word address extracted from the memory address when processing the read request in the cache memory device.

15. The FPGA of claim 13, wherein the processor core provides a write request to a data memory among the plurality of data memories, the data memory including data corresponding to a word address extracted from the memory address, and the processor core updates a dirty flag included in tag data of a set and a way corresponding to the write request when processing the write request in the cache memory device.

16. The FPGA of claim 13, wherein the processor core activates the plurality of data memories, divides read data from the external memory device into the plurality of word data, and stores the plurality of word data in the plurality of data memories.

17. The FPGA of claim 7, wherein the tag memory and the plurality of data memories are nonvolatile.

18. A method of controlling a cache memory device comprising a tag memory and a plurality of data memories, the method comprising:
receiving a request and a requested address;
extracting a tag address and a set address from the requested address;
reading tag data and word data from the tag memory and the plurality of data memories, respectively, the tag data and the word data being read from a plurality of ways of a set corresponding to the set address;
comparing the tag data with the tag address to determine whether there is a cache hit or a cache miss;
when there is the cache hit, determining whether the request is a write request or a read request;
when the request is the write request, writing write data in a corresponding data memory; and
when the request is the read request, outputting the word data read from the plurality of data memories.

19. The method of claim 18, when there is the cache miss, further comprising:
checking a dirty flag in the tag data to determine whether the dirty flag is in a dirty state or a non-dirty state;
when the dirty flag is in the dirty state, reading entire word data from the plurality of data memories, and storing the entire word data in an external memory device;
when the dirty flag is in the non-dirty state, reading data from the external memory device; and
storing the data read from the external memory device and corresponding tag data in the cache memory device.

20. The method of claim 18, wherein, when writing the write data, the method further comprises updating a dirty flag at a corresponding location of the tag memory.
